(19) United States
(12) Patent Application Publication
(10) Pub. No.: US 2011/0004570 A1
(43) Pub. Date: Jan. 6, 2011

(54) Non-debt, increasing-share, co-ownership to full ownership

(76) Inventors: Ahmed Aboul Makarem Saad, Leesburg, VA (US); Sabra Darcy Lutz, Leesburg, VA (US)

Correspondence Address: AHMED SAAD, 1013 Forbes NE, Leesburg, VA, 20176, US

(21) Appl. No.: 12/458,175

(22) Filed: Jul. 2, 2009

(51) Int. Cl. G06Q 90/00

(52) U.S. Cl. 705/500

(57) ABSTRACT

A method of debt-free property purchase through a partnership or any other form of co-ownership between a lead buyer (or buyers) and an investor (or investors) where the co-ownership is a separate legal entity whose sole purpose is to own, hold and manage a given property. The lead buyer may acquire additional percentage of the co-ownership over time towards full ownership, at a cost based on the latest assessed value. The co-ownership is best setup as a separate legal entity as it facilitates management of the property and gradual transfer of ownership. The co-ownership rents the property and the lead buyer has the first right to rent it. The co-ownership recognizes profit, loss, expense and responsibility for the property and distributes revenue. Lead buyers may choose to use their revenue to grow ownership share while investors may invest it, along with sale proceeds, in new co-ownerships.

### I. FIELD OF THE INVENTION

This invention concerns a method for enabling a buyer to purchase property debt-free in a manner compliant with Islamic principles (Shariah). It also enables a prospective buyer disinterested in debt or unable to secure a loan to purchase property. Property may be real estate, vehicles, machinery, industrial equipment, or any other property of value to a prospective buyer who lacks the immediate financial resources to acquire it without debt.

### II. BACKGROUND

Since Islamic principles (Shariah) prohibit interest, many Muslims will forgo buying property if the only realistic means of acquiring it is through a loan. Although this issue affects the purchase of property such as vehicles, land, machinery or industrial equipment, its greatest impact is on home purchase. While there has been some attention given to this niche market, all of it has focused on rewording or appending traditional mortgage contracts then finding a scholar to approve such modifications as being sufficient to comply with Shariah while still satisfying lending regulations (e.g. U.S. Pat. No. 7,516,099 and patent applications 20030233324, 20060136231, 20040205020, and 20040177029). Because the relationship is based on some form of interest-bearing debt, where the buyer is obligated to return the initial money provided in addition to a specified margin that is a function of time, lenders must observe the appropriate regulations. In fact, the only way for lenders to resell such contracts in the secondary market (which is the principle driver behind such schemes) is to conform to mortgage industry standards. Of course, this effectively negates any semblance of Shariah compliance since regulations force the lender to reveal that which is in fact taking place: the lender is extending an interest bearing loan. The very fact that such agreements are designed to conform to traditional mortgage standards to ensure sale in the secondary market in itself negates what little has been done by rewording or appending.

No matter how the terms have been reworded, the available arrangements all have the three elements of an interest-bearing loan: there is an amount of money extended from one party to another who has the obligation to repay it in excess of the amount lent, there is a predetermined rate of return, and the total amount repaid is a function of time. As such, both providers and regulations regard them as interest-based financing solutions requiring appropriate mortgage paperwork and disclosures. The providers place liens on the properties, conduct foreclosures if necessary, and coordinate or resell the contracts to national mortgage powerhouses such as Freddie Mac and Fannie Mae.

While some accept this as a solution, most reluctantly tolerate it as the only available option. Others simply reject it and abstain from participating in the housing market as they can see that the arrangement is no different than a traditional mortgage.

In addition to those who voluntarily abstain from taking interest-bearing loans, there are those with poor credit rating who are denied loans, or are forced to pay exorbitant rates. This happens even when their poor credit rating may have been a result of identity theft, stormy divorce, failed business or previous irresponsible behavior that has since been rectified.

In seeking a solution that genuinely adheres to Shariah there have been attempts by some, at a grassroots level, to pool money and buy each contributor a home—one at a time. The first contributor fortunate enough to be granted home ownership will then pay off the debt over time and the next contributor will purchase a home when enough money has once again been pooled. This has obvious limitations as it involves both debt (albeit non-interest based) and deprivation of other contributors' appreciation on their wealth, not to mention the frustration experienced by those contributors asked to wait while their money is used to purchase someone else a home. Needless to say, most such arrangements work only within a very limited scope and often fail to meet the desired goal.

A more progressive form of this thought, as instituted by Coop First LLC (http://coopfirst.com), is to design the aforementioned as a cooperative (co-op). The primary drawback of such arrangements is that few investors wish to provide funds due to insufficient return on investment. Despite the fact that investors in such programs do recognize a return on investment from rental in proportion to their remaining share (while the buyer is paying off the initial loan made to buy the house), what they often receive is a below-average return since the rent is usually fixed and does not rise as the rental market rises. Additionally, the investor does not recognize any appreciation in the value of the property (which is a significant component of any real estate investment) as there is no system in place to account for market changes over time. Moreover, the gradual divestment that occurs defeats the purpose for any investor who wishes to recognize returns over the long term. Like investors, buyers are also often less than happy since the title of the home is held solely by the co-op, giving them no legal right to the title no matter what percentage of the loan has been paid off. The title is transferred only after the loan is paid off in its entirety at which point it creates additional tax, legal and administrative consequences for the buyer. The relationship, while possibly amicable, is often perceived as inequitable by both parties; the investor sees below-average returns while the buyer feels that he is both renting and paying off a debt. In addition to all of the above mentioned deficiencies, there is no protection from the potential for liability to all parties due to the action of others. Consequently, this method also has a very limited scope and fails to solve the problem.

### III. SUMMARY OF THE INVENTION

This invention is a novel way to enable interested buyers to purchase property, debt-free, in a manner compliant with Shariah through a true co-ownership or partnership arrangement. The prospective property buyer (lead buyer) and the investor form a separate legal entity which is created with the sole purpose of owning, holding and managing a given property. Initial ownership percentage of the legal entity is proportionate to the initial investment made by each party. The legal entity then purchases the desired property becoming its sole owner, and the only party to recognize profit, loss, expense and responsibility for that property.

This method eliminates many complications for both the investor and the lead buyer as it offers protection of their rights and ensures appropriate management of the future relationship. There is no need for a prospective buyer to worry about having someone else's name on the title of their property or for investors to worry about lack of proper legal representation of their investment. Structuring it so that a separate legal entity owns the property protects both the lead buyer and the investor from actions of the other and asserts each party's rights and responsibilities. It ensures the best interest of the co-ownership not the best interest of any particular owner.

Since there is no debt involved, the lead buyer is not subject to foreclosure or complete loss of his investment. Each owner's percentage of the legal entity holding the property is secured while its value may increase or decrease due to market conditions. For example, in a case where the co-ownership, of which the lead buyer owns 10% and the investor owns 90%, buys a $200,000 house, the lead buyer would make an initial investment of $20,000 while the investor would pay $180,000 in proportion to their ownership percentage. If the market were to drop by 15% and the house were sold for $170,000, the lead buyer would get $17,000 and the investor would get $153,000. If the same scenario were to occur with a loan, not only would the borrowers entire investment be lost but he would owe the lender an additional $10,000.

Terms of the co-ownership allow the lead buyer to increase ownership share in the legal entity holding the property by incremental purchase of the investor's share at any time and in any amount. The legal entity periodically reassesses the current market value of the underlying property and consequently assesses a monetary value for each owner's share. The latest assessed monetary value then becomes the basis for calculating the cost for the lead buyer to purchase a given percentage of the investor's share, or alternatively, what percentage of the investor's share may be purchased for a given monetary amount. Subsequently, any purchase of the investor's share made by the lead buyer is always based on the latest assessed monetary value which allows the investor to recognize an appropriate return on the appreciation of the property.

Since the property is owned by a co-ownership, partnership, or legal entity of any other form, the property title is held by the legal entity. As the lead buyer increases ownership share in the legal entity he effectively increases ownership of the desired property. Upon acquiring full ownership of the legal entity, the lead buyer fully owns the property without complicated or costly paperwork.

The lead buyer may sell his share at any time, in which case, the investor has the first right to purchase the lead buyer's share also at a cost based on the latest assessed monetary value. If the investor declines to purchase the lead buyer's share, the lead buyer may compel the legal entity to sell the underlying property on the open market and distribute the proceeds proportionate to ownership percentage.

While the lead buyer may purchase an unlimited amount of the investors share at any time, the investor may require the purchase of a minimum percentage in a given time period to indicate the lead buyer's ongoing interest in full ownership of the legal entity holding the property. In the event that the lead buyer purchases less than the agreed upon percentage during any agreed upon time period, the investor may compel the legal entity to sell the underlying property. Alternatively, the lead buyer's share in the co-ownership may be sold to an interested buyer.

Once the property is purchased, the legal entity will rent it to the lead buyer or to any other renter deemed suitable, at rates and terms consistent with existing market norms. Although the lead buyer has the first right to rent or lease the property he is not required to do so. However, if the lead buyer declines to rent it and no suitable renters are readily available, the investor may compel sale of the underlying property if it fails to generate a reasonably consistent flow of rental revenue. Alternatively, the lead buyer's share in the co-ownership may be sold to an interested buyer.

An important concern for any investor renting a property is the risk that the renter may damage it, but since the renter in this model is expected to be the lead buyer (who is an investor in the property himself) it minimizes or eliminates the risk of damage to the property.

The lead buyer renting the property may only make updates, upgrades, improvements or modifications to the property with approval of the legal entity. All or a portion of the cost of an approved improvement or modification may be borne by the legal entity to the extent that it provides an equivalent long-term value to the property and is agreeable to all owners.

The legal entity is responsible for paying expenses, collecting rent and maintaining administrative and ownership records. It is also responsible for distributing the net revenue generated in proportion to percentage of ownership. The lead buyer, being interested in full ownership, may use some or all of his distributed revenue to purchase additional percentage of the investor's share in the legal entity thereby accelerating growth of ownership.

While paying expenses, collecting rent, and distributing revenue may not be as complicated in a traditional partnership (where the initial percentage of investment for each partner remains the same or changes infrequently), it can be a challenge in a co-ownership where the percentage of each owner is continually changing. Having a separate legal entity own and hold the property eliminates the need to calculate what portion of a given expense is owed by each co-owner, and the need to recalculate future expense as ownership percentages change. Similarly, the same structural advantage eases the distribution of revenue.

Since traditional partnerships involve investors who seek long-term return on their investment, it is not in their best interest to sell portions of their share as the goal is to fully invest their money, not to gradually divest it. This method uniquely solves such problems. It provides a way for the lead buyer to achieve the goal of owning property and for investors to gain the full benefit of their investment while keeping their money fully invested. The lead buyer gradually purchases shares of the legal entity until eventually owning the co-ownership and therefore the underlying property. The investors receive rental revenue from a multiplicity of properties, in addition to the monies paid by various lead buyers purchasing shares of their respective co-ownerships. The total amount of money received is therefore significant and can be used for reinvestment in a relatively short period of time with other lead buyers in new properties. So, rather than any given investment being divested, the investor will simply shift the expected return from the foregone potential appreciation of a given property to that of another in similar market conditions.

For example, investors buying property during a depressed real estate market would like to recognize the appreciation on the value of the property as the market turns around and selling portions of their share would deprive them of a corresponding portion of appreciation. However, in our model multiple streams of rental revenue in addition to monies paid by various lead buyers make it possible to immediately reinvest the revenue in another property with similar market conditions. This effectively, shifts the investment appreciation potential for investors from one property to another without depriving them of the appreciation itself. Therefore, both the lead buyer and the investor gain from the bargains of a depressed market since the lead buyer grows his share in the co-ownership at a cost assessment based on the depressed market value, while the investor reinvests the funds in new properties that are equally promising. As such, the investor is able to spread the risk (which is limited to only a portion of any given property) over multiple properties while having a caring renter readily available so the investment generates immediate revenue. The lead buyer continues the march to full ownership while the investor takes full advantage of the investment potential.

### IV. BRIEF DESCRIPTION OF THE DRAWINGS AND FIGURES

The aforementioned benefits and features of this invention and the manner of implementing it will best be understood by referring to the following description in conjunction with the accompanying figures.

FIG. 1 in accordance with the present invention shows the relationship between a prospective property buyer (lead buyer) and an investor where the co-ownership they form is a separate legal entity.

FIG. 2 in accordance with the present invention shows multiple co-ownerships between the investor and multiple lead buyers with differing percentages of initial ownership.

FIG. 3.1-FIG. 3.6 in accordance with the present invention shows a co-ownership between a lead buyer and an investor where the lead buyer increases ownership share over time.

FIG. 4 in accordance with the present invention shows the co-ownership as the sole owner of the property. It collects rent, pays expenses and distributes revenue.

FIG. 5 in accordance with the present invention shows the lead buyer using his portion of the distributed revenue to purchase an additional amount of the investor's share thus accelerating growth of ownership.

FIG. 6.1-FIG. 6.4 in accordance with the present invention shows the lead buyer growing his share in the co-ownership by buying portions of the investor's share at a cost based on the latest assessed value of the co-ownership which is based on the market value of the underlying property.

FIG. 7 in accordance with the present invention shows a flowchart for rental of the property.

FIG. 8 in accordance with the present invention shows a flowchart for the lead buyer's share purchase from the investor.

FIG. 9 in accordance with the present invention shows the flowchart for sale of the lead buyer's share.

### V. DETAILED DESCRIPTION OF A PREFERRED EMBODIMENT OF THE INVENTION

The following description and accompanying drawings detail the features and advantages of the exemplary embodiment(s) of this invention. It is illustrative only and all the features disclosed in this description may be replaced by alternative features serving the same purpose, and equivalents or similar purpose, unless expressly stated otherwise.

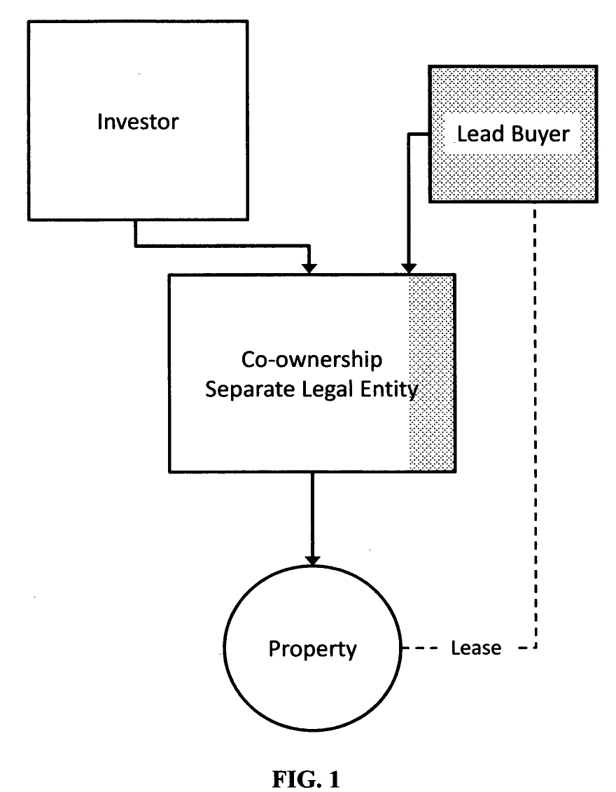

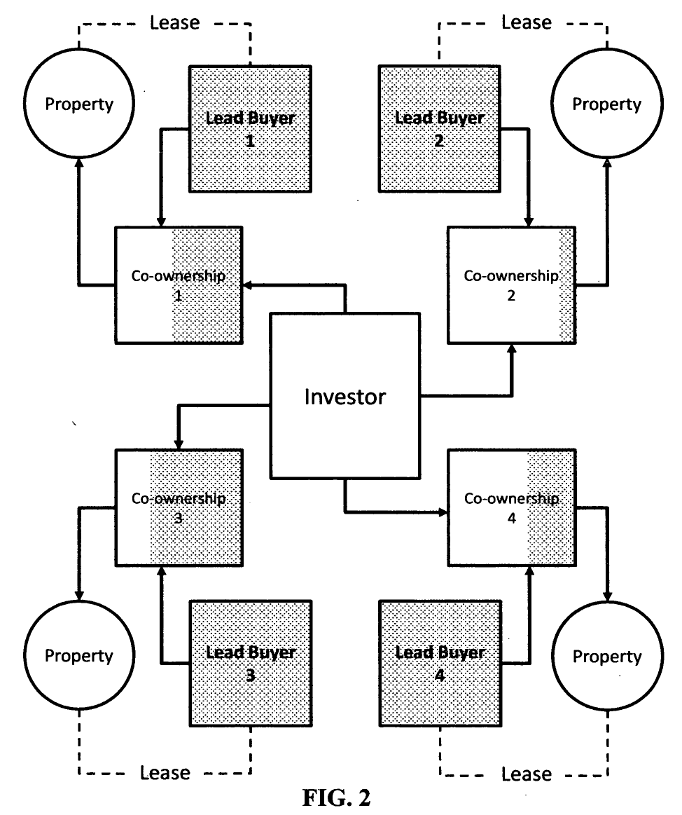

FIG. 1 shows a lead buyer, interested in acquiring a given property debt-free, entering into a partnership with an investor. The two parties form a separate legal entity (co-ownership) whose sole purpose is to purchase, own, hold and manage the desired property. The ownership percentage of the legal entity is based on each party's initial investment. The co-ownership then purchases the property becoming its sole owner. Once the property is purchased, the co-ownership will lease the property where the lead buyer has the first right to lease it. Since the amount of initial investment made by a lead buyer can vary, as shown in FIG. 2, the investor may have a multitude of investments with many lead buyers, each with a different percentage of ownership suitable to the respective lead buyer and agreeable to the investor.

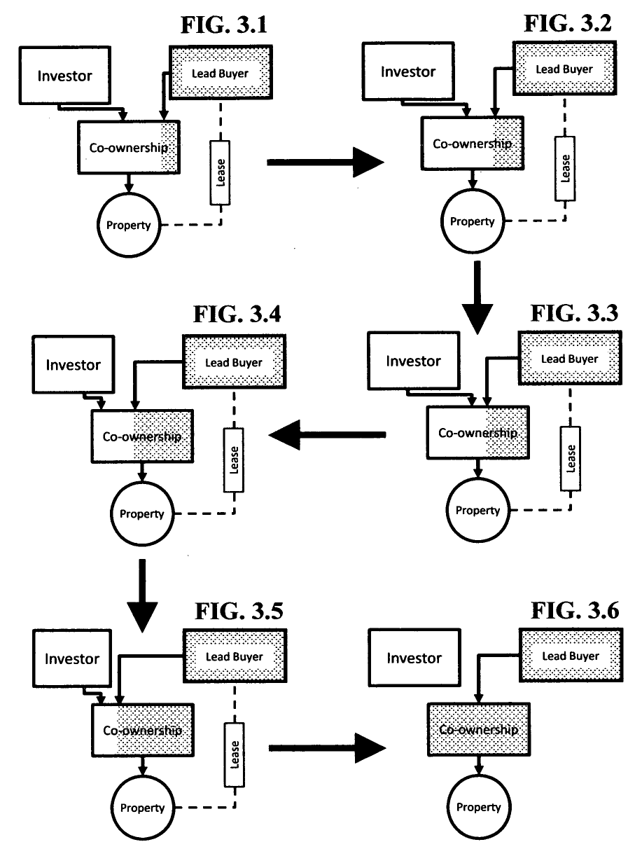

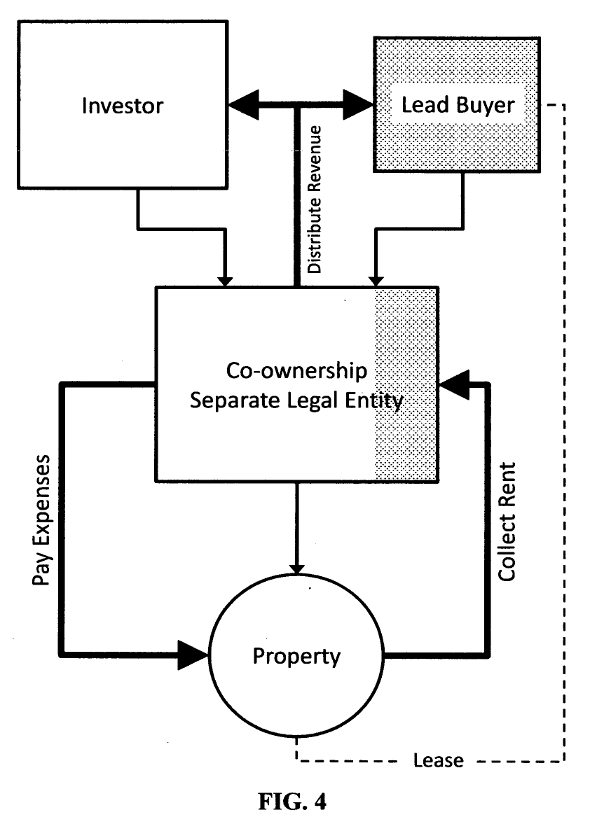

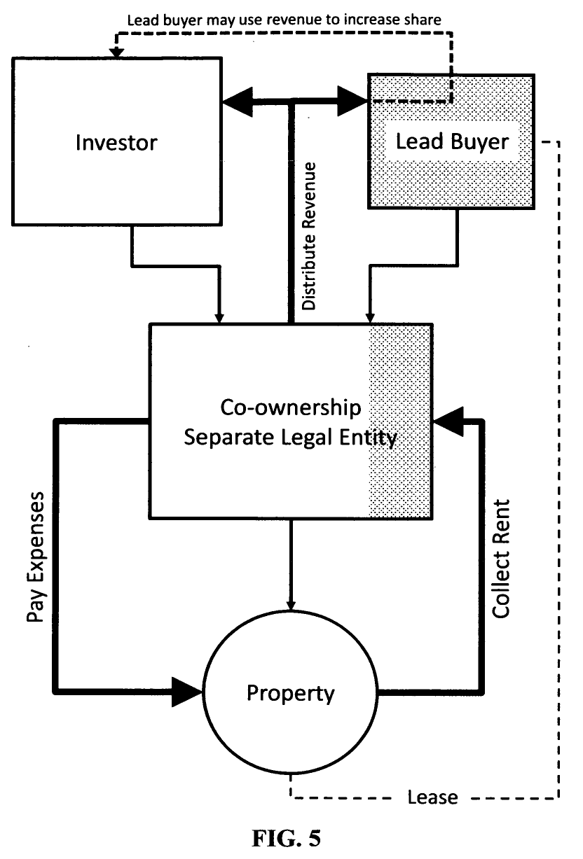

The lead buyer can grow his ownership percentage in the legal entity holding the desired property at a rate suitable to him as shown in FIG. 3.1-3.6. The lead buyer may grow his ownership at any time and by any amount, until he fully acquires the co-ownership. In the meantime, as shown in FIG. 4, the co-ownership will collect rent and pay expenses, then distribute net revenue to the co-owners based on the percentage of ownership on record. As shown in FIG. 5, the lead buyer may use his portion of the distributed revenue to purchase a portion of the investor's share thereby accelerating the growth of his share.

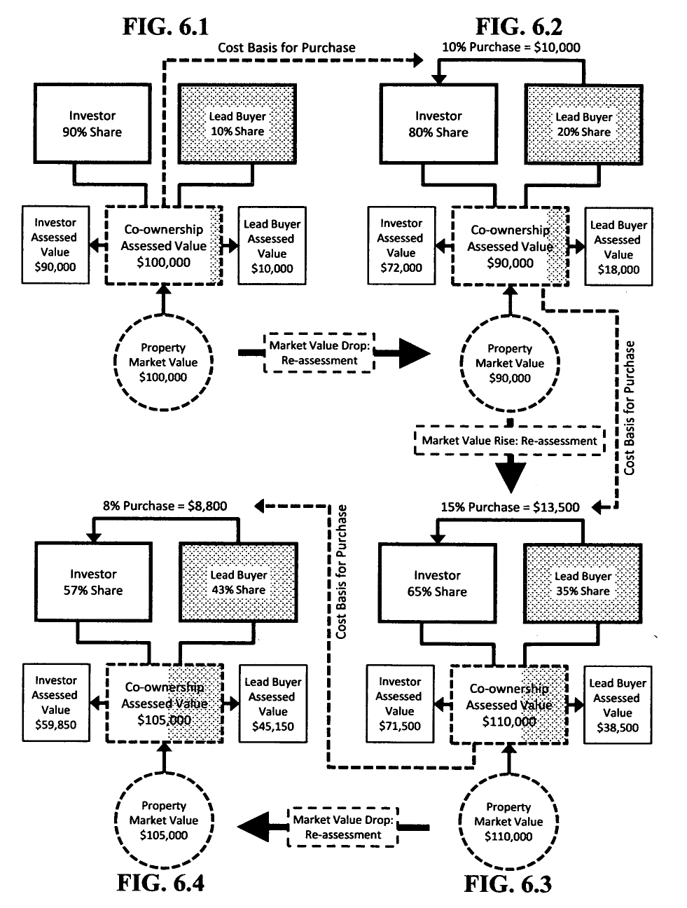

FIG. 6.1-6.4 shows the cost basis for the lead buyer's purchase of portions of the investor's share. Since the co-ownership is created solely to buy, hold and manage a given property, the value of the partnership is principally determined by the market value of that property. In the example shown, the value of the co-ownership corresponds directly to the value of the property for simplicity. At times where there are retained earnings or unpaid expenses in accounts payable, the value of the co-ownership may be higher or lower respectively. The assessed value of the each owner's share is based on percentage of ownership. FIG. 6.1 shows a co-ownership in which the investor owns 90% and the lead buyer owns 10% and where it is assessed at $100,000 based on the property's market value. During a given time period, the lead buyer purchases an additional 10% of the co-ownership based on the latest assessed value, which is the value shown in FIG. 6.1, by paying the investor $10,000. At the end of the time period the lead buyer owns 20% at which point market conditions change and the value of the underlying property drops to $90,000 as shown in FIG. 6.2 and thus changing the co-ownership's assessed value. The latest assessed value of $90,000 then becomes the cost basis for further purchase of the investor's share. During the next time period, (from FIG. 6.2 to FIG. 6.3) the lead buyer purchases an additional 15% of the co-ownership from the investor for only $13,500 (based on the latest assessment of $90,000 shown in FIG. 6.2) at which point the lead buyers share rises to 35%. Further changes in market conditions at the end of the time period (as shown in FIG. 6.3) cause the property value to rebound and the co-ownership's assessed value stands at $110,000 and the lead buyer's 35% is valued at $38,500. The $110,000 assessed value of the co-ownership in FIG. 6.3 is the cost basis for subsequent purchase. During the next time period the lead buyer purchases 8% of the co-ownership from the investor at a cost of $8,800, growing his share to 43% (from FIG. 6.3 to 6.4). The new assessed value of the lead buyer's share becomes $45,150 based on the $105,000 assessed value of the co-ownership as shown in FIG. 6.4. The legal entity will therefore periodically update its assessed value to reflect changes in market conditions that affect the underlying property's value and the lead buyer's subsequent purchase of the investor's share will always be based upon the latest assessed value of the co-ownership.

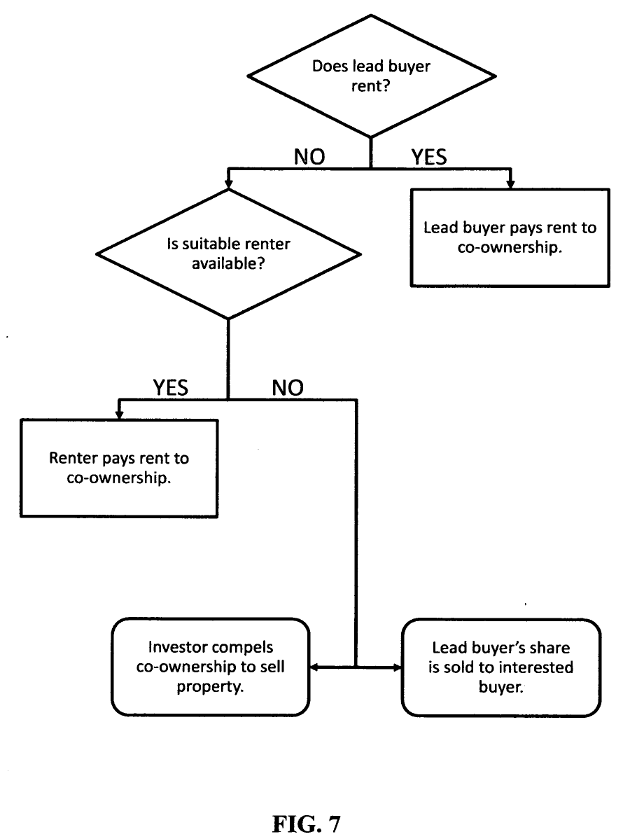

FIG. 7 shows the flowchart for rental of the property. While not obligated to, the lead buyer has the first right to lease or rent the property and is generally expected to do so. Should the lead buyer be disinterested in leasing or renting the property, or discontinue leasing or renting it, the co-ownership will lease or rent the property to a renter or renters deemed suitable. In the event that the lead buyer is not renting the property and a suitable renter is not available within a reasonable amount of time, the investor may compel the co-ownership to sell the underlying property on the open market and distribute the proceeds to the owners based on percentage of ownership. Alternatively, the lead buyer's share in the co-ownership may be sold to an interested buyer.

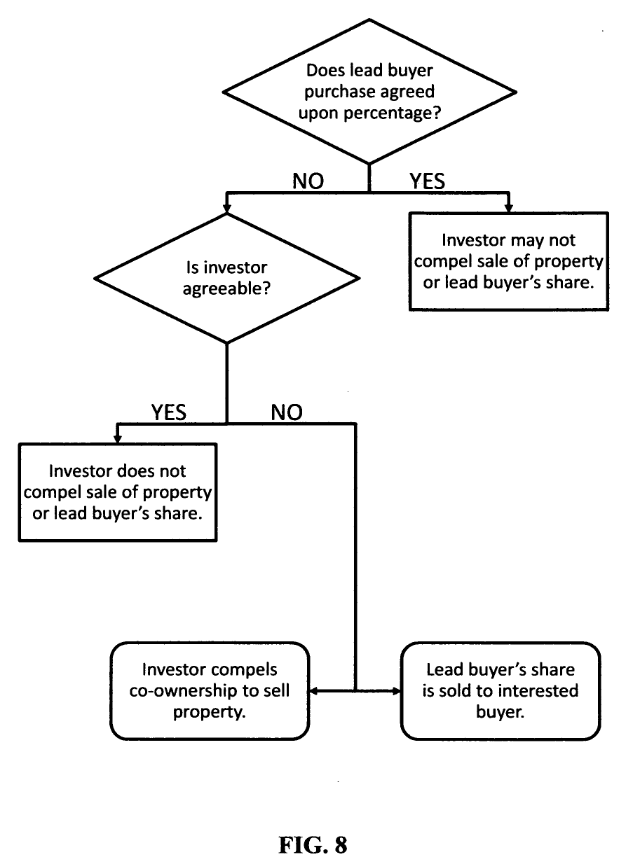

The lead buyer has the right to purchase as much of the investor's share in the co-ownership as he likes at any time (at a cost based on the most recent assessed value). However, as shown in FIG. 8 the investor may require the purchase of a minimum percentage in a given time period to indicate the lead buyer's continued interest in full ownership of the co-ownership. Should the purchase of that minimum percentage not be made by the lead buyer during any agreed upon time period, the investor may compel sale of the property on the open market and the co-ownership will distribute the proceeds based on percentage of ownership. Alternatively, the lead buyer's share in the co-ownership may be sold to an interested buyer.

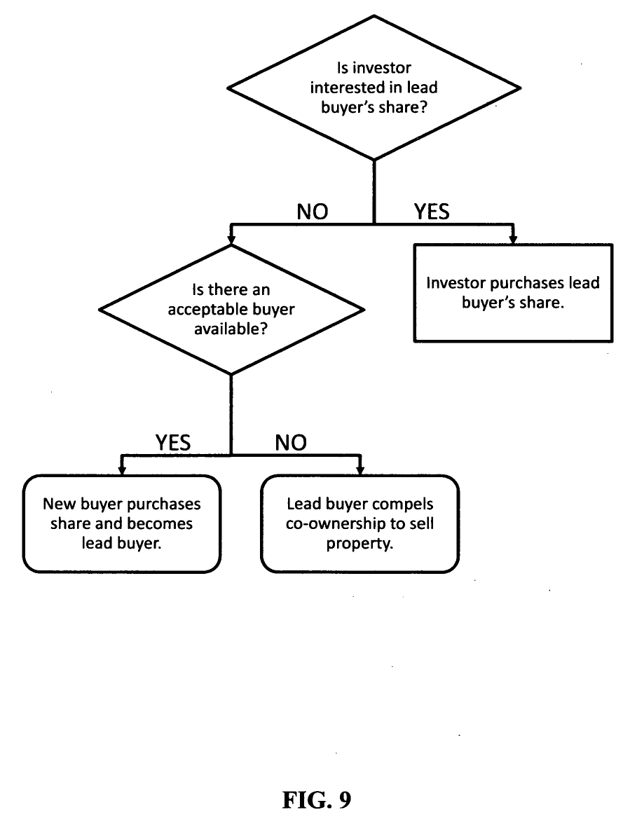

The lead buyer is not required to grow his share to full ownership. It may be of interest to sell the property due to the lead buyer's need or desire. The investor may be interested in acquiring the lead buyer's share to keep or resell, in part or as a whole, to another interested buyer. As shown in FIG. 9 the investor has the first right to purchase the lead buyer's share at the latest assessed value. If the investor is disinterested, the lead buyer may compel the co-ownership to sell the property on the open market and distribute the proceeds based on percentage of ownership. Alternatively, the lead buyer's share in the co-ownership may be sold to an interested buyer.

The lead buyer leasing or renting the property may only make updates, upgrades, improvements or modifications to property with approval of the owners of the legal entity. All or a portion of the cost of an approved improvement or modification may be borne by the legal entity but only to the extent that it adds an equivalent long-term value to the property and is agreeable to all owners. Should the investor approve a given update, upgrade, improvement or modification but see no long-term value added to the property, he may decline to participate in funding it. In this case, the lead buyer has the right to perform the update, upgrade, improvement or modification at his own expense.

Because there is no debt involved, the lead buyer is not subject to foreclosure or complete loss of his investment. Each owner's percentage of the legal entity holding the property is secured while its value may increase or decrease due to market conditions. Since the property title is held by the legal entity, the lead buyer effectively acquires full ownership of the desired property upon acquiring full ownership of the legal entity without going through complicated or costly paperwork.

In summary, this method gives the prospective property buyer a path to ownership with no debt, loan or repayment commitment. Since the partnership is its own legal entity, concerns regarding its ability to continue should the investor die or become insolvent are alleviated. There is no need for the lead buyer to worry about the title of his future home being held by the courts until issues related to a partner's heirs, or an insolvent company's creditors, are sorted out since the title is held by a separate legal entity. Likewise, it offers protection of the property for the investor in the event of the lead buyer's insolvency or other action that may impact joint assets. In the case of the lead buyer's death, the heirs will inherit his ownership share and the partnership will simply continue with its terms without impact on the investor. It also has the added advantage of making it easier to do proper accounting, collect rent, pay expenses, and to record share purchases and changes in ownership percentages. Having a separate legal entity hold the property also ensures that the rules agreed upon at the outset of the partnership will not change midstream at the whimsy of any party.

Investors are able to receive fair and accurate valuation for their investment from rental revenue and property appreciation via periodic reassessment. Unlike individual investments made by a single investor, this method leverages pooled money and enables diversification, reinvestment, and proper management of assets. Since the investor and the lead buyer share in profit, loss, expense and responsibility by virtue of their joint ownership of the legal entity holding the property, the investor is equally able to receive returns on his investment as the lead buyer. In return, the lead buyer is not solely burdened with expenses, taxes or property depreciation but carries only that which is proportionate to his ownership percentage.

This method offers the same full investment potential as that of traditional real estate investment with regard to rent, property appreciation, and spreading the risk across multiple properties but has the added advantage of a caring tenant being immediately available. This effectively eliminates the two biggest challenges facing any landlord, occupancy and property care, since the tenant is a partner in the property and is expected to care for it more than the average renter. Because the lead buyer gradually purchases ownership share from the investor it minimizes the investor's risk in any given property and secures incremental recognition of property appreciation. It increases the amount of available funds and enables a faster turnaround time for reinvestment in the market which is especially critical when the market is down and investment opportunities require quick action.

### CONCLUSION

Having described a preferred embodiment of the invention, it should be apparent to those skilled in the art that the foregoing is illustrative only and not limiting. The description above is presented by way of example only.

Property can be anything of value, including but not limited to real estate, vehicles, machinery, industrial equipment and intangibles. All the features disclosed (including any accompanying claims, abstract, and drawings) may be replaced by alternative features serving the same purpose, and equivalents or similar purpose, unless expressly stated otherwise. Therefore, other embodiments of the modifications thereof are contemplated as falling within the scope of the present invention as defined by the appended claims and equivalents thereto.

What is claimed is:

1. A method of debt-free property purchase wherein a lead buyer or buyers (individuals or any legal entity), and an investor or investors (individuals or any legal entity) form a separate legal entity (partnership, LLP, LLC, Incorporation, Trust, or any other form of legal entity) whose sole purpose is to own, hold and manage a given property.

2. The method of claim 1, wherein the percentage of initial ownership of said separate legal entity is proportionate to the initial investment of each party.

3. The method of claim 1, wherein said separate legal entity purchases a given property.

4. The method of claim 3, wherein said separate legal entity is the sole owner of said property and is the only party that recognizes profit, loss, expense and responsibility for said property.

5. The method of claim 3, wherein said separate legal entity periodically reassesses the current market value of underlying said property and assesses a monetary value for the legal entity and each co-owner's share.

6. The method of claim 2, wherein the lead buyer may increase his share in said separate legal entity by incremental purchase of the investor's share.

7. The method of claim 5, wherein the lead buyer may purchase the investor's share, or any portion of it, where the latest assessed monetary value is the basis for calculating the cost for the lead buyer to purchase a given percentage of the investor's share, or what percentage of the investor's share can be purchased for a given monetary amount.

8. The method of claim 6, wherein the investor may compel said separate legal entity to sell the underlying property in the event that the lead buyer purchases less than an agreed upon minimum percentage of said separate legal entity from the investor during an agreed upon time period.

9. The method of claim 6, wherein the lead buyer's share in said separate legal entity may be sold to an interested buyer in the event that the lead buyer purchases less than an agreed upon minimum percentage of said separate legal entity from the investor during an agreed upon time period.

10. The method of claim 1, wherein the lead buyer may sell his share at any given time.

11. The method of claim 5, wherein the investor has the first right to purchase the lead buyer's share at the latest assessed value should the lead buyer wish to sell.

12. The method of claim 11, wherein the lead buyer may compel said separate legal entity to sell the underlying property if no interested buyer is available to purchase the lead buyer's share.

13. The method of claim 3, wherein the underlying property owned by said separate legal entity is leased or rented to a renter or renters deemed suitable by the owners of said separate legal entity.

14. The method of claim 13, wherein the lead buyer has the first right to rent or lease said property from said separate legal entity.

15. The method of claim 13, wherein the investor may compel said separate legal entity to sell the underlying property if said property fails to generate a reasonably consistent flow of rental revenue.

16. The method of claim 13, wherein net revenue is distributed by said separate legal entity to its owners proportionate to percentage of ownership.

17. The method of claim 16, wherein the lead buyer may use some or all of his portion of said distributed revenue to purchase additional percentage of the investor's share in said separate legal entity.

18. The method of claim 14, wherein the investor may compel said separate legal entity to sell the underlying property if the lead buyer is not renting or leasing said property.

19. The method of claim 14, wherein the lead buyer's share in said separate legal entity may be sold to an interested buyer in the event that the lead buyer is not renting or leasing said property.

20. The method of claim 14, wherein the lead buyer leasing or renting said property may only make updates, upgrades, improvements or modifications to said property with the approval of all owners of said separate legal entity holding the property.

21. The method of claim 20, wherein all or a portion of the cost of a given approved improvement or modification may be borne by said separate legal entity to the extent that it provides an equivalent long-term value to said property and is agreeable to all owners of said separate legal entity.

22. The method of claim 20, wherein the cost of said approved improvements or modifications may be borne solely by the lead buyer.
